(19) United States
(12) Patent Application Publication
(10) Pub. No.: US 2014/0306495 A1
(43) Pub. Date: Oct. 16, 2014

(54) PATIENT CARRIER

(71) Applicant: UNIVERSITY HEALTH NETWORK, Toronto (CA)

(72) Inventors: Gerald Thomas GRIGGS, Keswick (CA); Geoffrey Roy FERNIE, Etobicoke (CA); Adam Mathew SOBCHAK, Toronto (CA); Emily Catherine KING, Etobicoke (CA); Tilak DUTTA, Toronto (CA)

(73) Assignee: UNIVERSITY HEALTH NETWORK, Toronto (CA)

(21) Appl. No.: 14/249,574

(22) Filed: Apr. 10, 2014

Related U.S. Application Data
(60) Provisional application No. 61/811,046, filed on Apr. 11, 2013.

(51) Int. Cl. A61G 5/10

(52) U.S. Cl. CPC A61G 5/1002; A61G 5/1072
USPC 297/188.08; 297/313; 297/188.01

(57) ABSTRACT

A patient carrier comprises a patient support configured to be locatable above a toileting receptacle. The patient support includes a back support portion, a leg support portion, and a seat support portion. The patient support is movable about a first axis between an upright orientation and an inclined orientation. The seat support portion is movable about a second axis relative to the back support portion and leg support portion, and is operable to transition between a seating configuration and a toileting configuration when the patient support is in the inclined orientation.

### REFERENCE TO CO-PENDING APPLICATION

This application claims the benefit of U.S. Provisional Patent Application Ser. No. 61/811,046 entitled “PATIENT CARRIER” filed Apr. 11, 2013, the entirety of which is incorporated by reference herein.

### FIELD

The present disclosure relates to patient carriers, such as toileting carriers.

### BACKGROUND

An unfortunate condition for infirm patients is the inability to toilet independently. Commode chairs, though satisfactory, do not offer comfort for the patient, nor the caregiver. It would be desirable to provide a novel approach.

### SUMMARY OF THE GENERAL INVENTIVE CONCEPT

The following presents a simplified summary of the general inventive concept herein to provide a basic understanding of some aspects of the invention. This summary is not an extensive overview of the invention. It is not intended to restrict key or critical elements of the invention or to delineate the scope of the invention.

In an exemplary embodiment, there is provided a patient carrier, comprising a patient support configured to be locatable above a toileting receptacle. The patient support includes a back support portion, a leg support portion, and a seat support portion. The patient support is movable about a first axis between an upright orientation and an inclined orientation. The seat support portion is movable about a second axis relative to the back support portion and leg support portion, and is operable to transition between a seating configuration and a toileting configuration when the patient support is in the inclined orientation.

In some exemplary embodiments, the seat support portion includes a seat frame portion configured to support a seat support cushion segment and/or a toileting seat segment removably positioned thereon. Some exemplary embodiments may provide the seat support cushion segment portion to be removably attached to the toileting seat segment, where the toileting seat segment remains on the seat frame portion.

Some exemplary embodiments may further comprise a first drive portion to transfer the patient support between the upright orientation and inclined orientations, and/or a second drive portion to transfer the seat support portion between the seating and toileting configurations.

In some exemplary embodiments, the first and second drive portions are located in a region behind the back support portion when the patient support is in the upright orientation.

Some exemplary embodiments may further comprise a receptacle support for the toileting receptacle.

In some exemplary embodiments, the receptacle support is movable from an operative position beneath the seat support portion to a location distal thereto.

In some exemplary embodiments, the receptacle support includes a platform with a passage to receive a portable toileting receptacle.

In some exemplary embodiments, the first axis is spaced from the second axis.

In another exemplary embodiment, there is provided a method of preparing a patient carrier for toileting, comprising:
i) orienting the patient carrier in an upright orientation, with a back support portion, a leg support portion, and a seat support portion available for supporting a patient;
ii) with the seat support in a seating configuration, transitioning the patient carrier to an inclined orientation;
iii) with the patent carrier in the inclined position, and with the back support and leg support positions oriented to support the patient, transitioning the seat support portion from the seating configuration to a toileting configuration; and
iv) transitioning the patient support to a toileting orientation which is configured to be above a toileting receptacle.

In an exemplary embodiment, there is provided a toileting carrier, comprising a patient support movable about a first axis relative to a base. The patient support includes a back support portion, a pair of arm support portions, and a leg support portion. A seat support portion is movable about a second axis relative to the back portion and leg support portions, between a first patient supporting position and a second position distal thereto. The base is configured to permit a toileting receptacle to be located beneath the seat support portion. The seat support portion includes a seat frame portion which is configured to support a seat support cushion segment or a toileting seat segment removably positioned thereon. A first drive portion transfers the patient support between an upright orientation and an inclined orientation, while a second drive portion to transfer the seat support portion between the first and second positions.

In an exemplary embodiment, the leg support portion is arranged to align with a patient's legs below the patient's knees. The patient support includes a pair of side frame portions each extending from the back support portion to a distal region, and a foot support portion extending between the side frame portions.

In an exemplary embodiment, the base provides a pair of first pivot portions to form the first axis. The back support portion includes a back frame, which further includes a pair of end regions coupled with the pivot portions. The base is further configured to permit the carrier to be located over a toilet for use by the patient when the chair is in the upright orientation. The back support portion includes an upper back support member and a lower back support member, the latter extending between the end regions. The first and second drive portions are confined to a region behind the back support portion when the patient support is in the upright orientation.

In an exemplary embodiment, the seat support portion includes a seat frame member, and a pair of second pivot portions couple the seat frame member to the back support portion. The back support portion includes a second cross member, and the second pivot portions couple corresponding ends of the seat support portion to the second cross member. The seat support portion includes a third cross member, and the second drive portion is mounted between the third cross member and the back support portion.

In an exemplary embodiment, the base has a pair of base frame members with a respective pair of upper end regions. A cross member extends between the base frame members near the upper end regions. The first drive portion includes a base portion mounted on the cross member.

In an exemplary embodiment, the base includes a receptacle support for the toileting receptacle. In some cases, the receptacle support is movable from an operative position beneath the seat support portion to a location distal thereto. The receptacle support may include a platform positioned on the base with a passage to receive a portable toileting receptacle.

In an exemplary embodiment, the carrier is configured to transfer the back and leg support portions between the upright and inclined orientations, under the action of the first drive portion, and to transfer the seat support portion between the proximal and distal positions under the action of the second drive portion, when the back support portion is in the inclined orientation.

In another embodiment, there is provided a method of supporting a patient for a toileting function, comprising:
i) comfortably and supportably seating the patient on a patient support having a back support portion, a leg support portion and a seat support portion, with the leg support portion able to engage the patient adjacent the knee and along an upper calf region of the patient's legs;
ii) inclining the back, seat and leg support portions collectively to deliver the patient to an inclined position, to a sufficient degree that the patient's weight is comfortably supported between the back support portion and the leg support portion;
iii) transferring the seat support portion from a patient-contacting location to a distal location sufficient to convert the seat support portion from a non-toileting configuration to a toileting configuration, and returning the seat support portion to its patient-contacting location;
iv) righting the back, seat and leg support portions collectively to deliver the patient to an upright position, in which the seat support portion is aligned with and above a toileting receptacle.

### BRIEF DESCRIPTION OF THE DRAWINGS

Several exemplary embodiments will be provided, by way of examples only, with reference to the appended drawings, wherein:

FIGS. 1 and 2 are perspective views of a patient carrier in an upright orientation;

FIG. 3 is magnified fragmentary perspective view of a central area of the carrier of FIG. 1, with the carrier in the upright orientation;

FIG. 4 is an opposite magnified fragmentary perspective view of the area of FIG. 3, with the carrier in an inclined orientation;

FIG. 5 is a rear view of the carrier of FIG. 1;

FIGS. 6 and 7 are progressive views of the carrier in respective intermediate and upright orientations;

FIGS. 8 to 12 are progressive views of the carrier in transition to an intermediate toileting configuration, while in the inclined orientation of FIG. 7;

FIGS. 13 to 15 are progressive views of the carrier in transition to an upright toileting configuration; and

FIG. 16 is a perspective view of another patient carrier.

### DESCRIPTION OF THE EXEMPLARY EMBODIMENTS

It should be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical, mechanical or electrical connections or couplings. Furthermore, and as described in subsequent paragraphs, the specific mechanical and/or electrical, other configurations illustrated in the drawings are intended to exemplify embodiments of the invention. However, other alternative mechanical and/or electrical or other configurations are possible which are considered to be within the teachings of the instant disclosure.

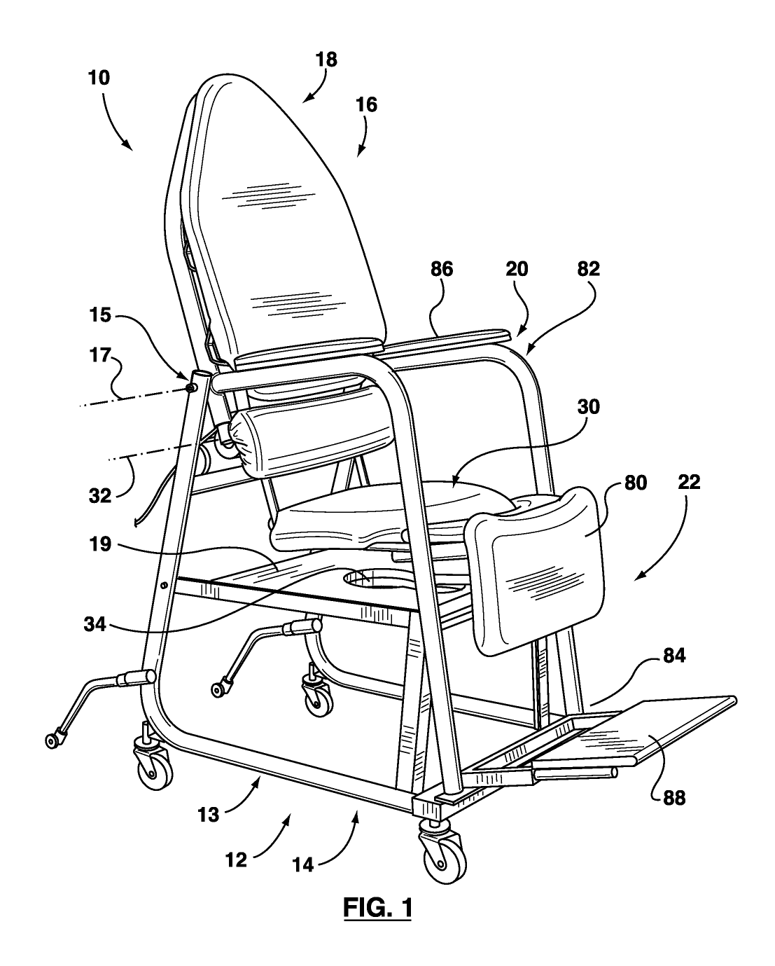

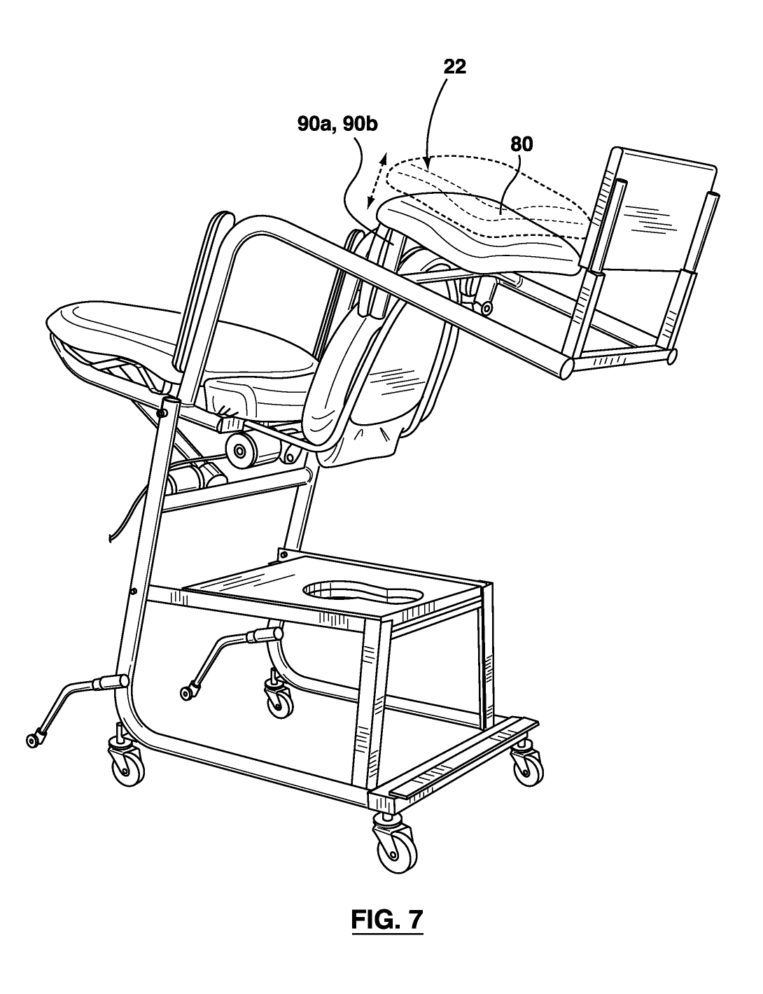

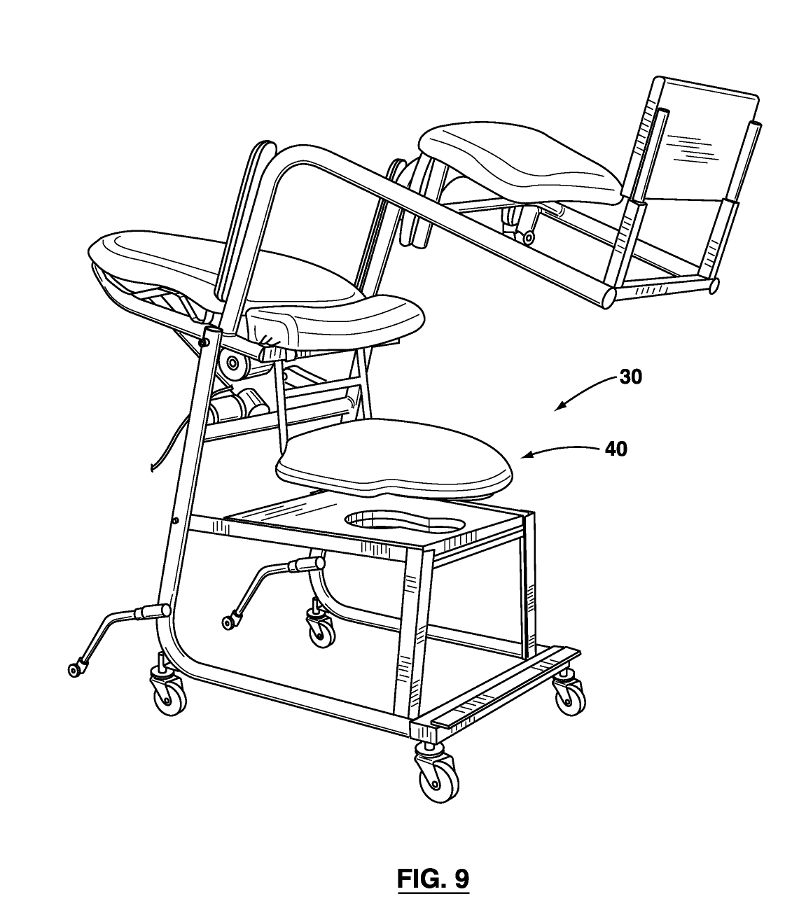

FIG. 1 illustrates a patient carrier 10, comprising a base 12 with an undercarriage 14. A patient support 16 includes a back support portion 18, a pair of arm support portions 20, and a leg support portion 22. The patient support 16 is movable about a first axis 17 relative to the base 12, between an upright orientation, as shown in FIG. 1, and an inclined orientation as shown in FIG. 7. A seat support portion 30 is movable about a second axis 32 relative to the back support portion 18 and leg support portion 22 between a first patient supporting position, as shown in FIG. 7, and a second intermediate position distal thereto, as shown in FIG. 9, as will be described.

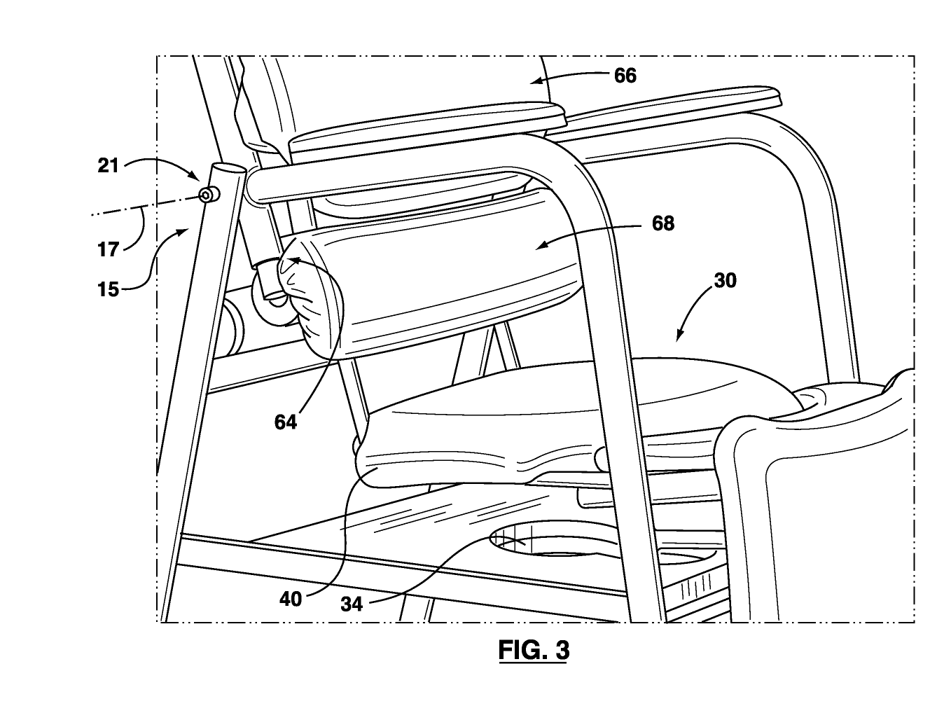

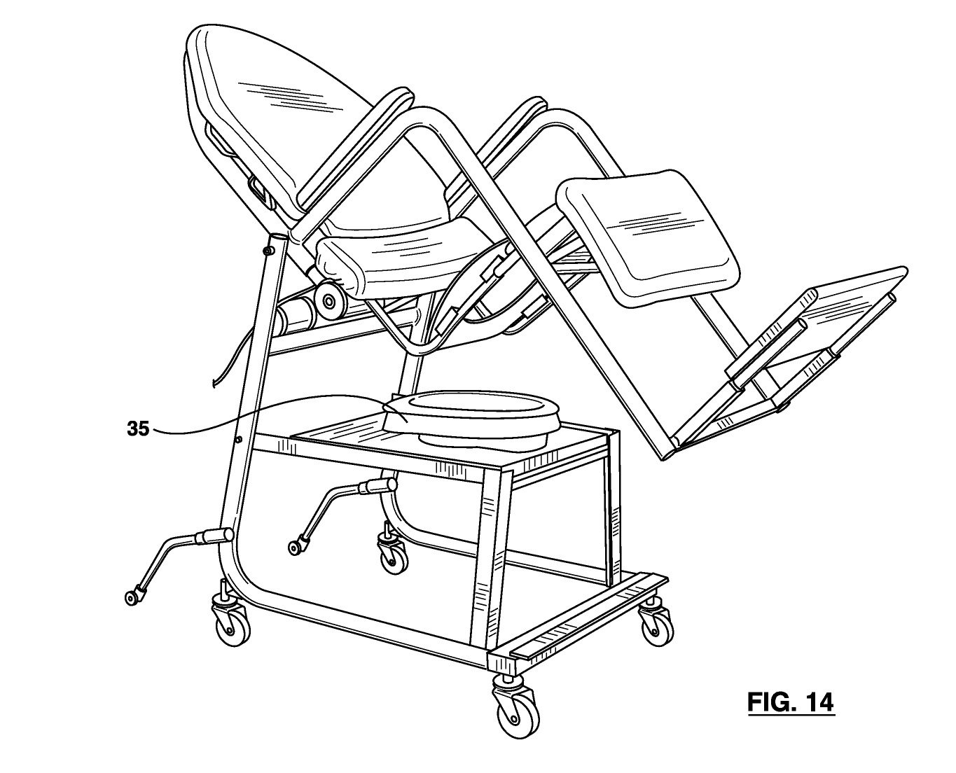

The base 12 has a pair of base frame members 13 extending along respective sides of the carrier 10. Extending between the base 12 is a platform portion 19 with a toileting receptacle location 34 in the form of an aperture to receive a toileting receptacle 35 (FIG. 14). Referring to FIGS. 1 and 3, each base frame member 13 extends along a side region of the carrier 10, and has an upper end region 15. A pair of first pivot portions 21 is located at the respective upper end regions 15 to form the first axis 17. It can be seen that, in this example, first axis 17 is spaced form second axis 32, though other configurations may provide the first and second axes to be coaxial, if desired.

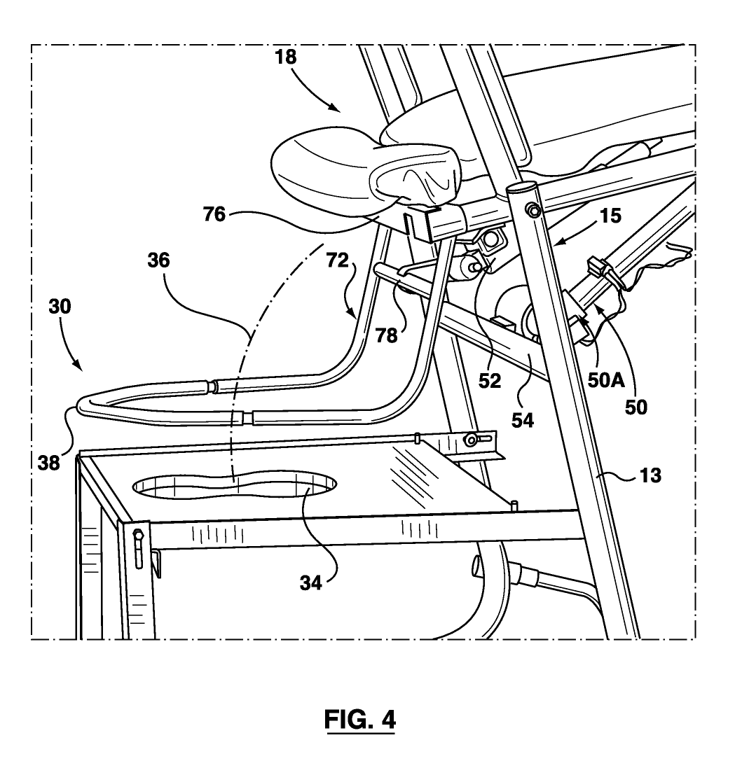

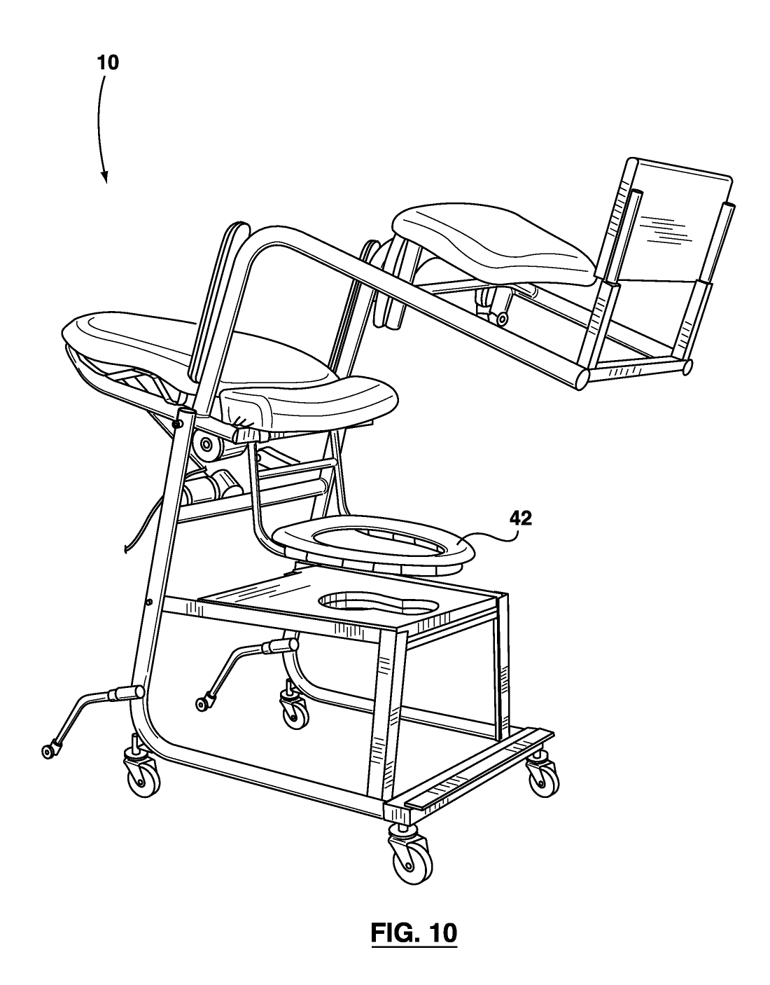

Referring to FIGS. 3 and 4, the toileting receptacle location 34 is in a travel path 36 of the seat support portion 30. The seat support portion 30 includes a seat frame 38 configured to support a seat support cushion 40 (FIG. 3) or a toileting seat 42 (FIG. 10) removably positioned thereon, depending on the operating mode of the carrier 10 as will be described. A first drive portion, in the form of a first drive unit 50 (FIG. 4) is provided to transfer the patient support 16 between an upright orientation (FIG. 1) and an inclined orientation (FIG. 7), while a second drive portion, in the form of a second drive unit 52 is provided to transfer the seat support portion 30 between the first patient supporting position (FIG. 7) and the intermediate position, as shown in FIG. 9, as will be described. In this case, a first cross member 54 (FIG. 4) extends between the base frame members 13 near the upper end regions 15. In this case, the first drive unit 50 includes base portion 50A mounted on the cross member 54. The first and second drive units 50, 52 each include a linear actuator, in this example, though other drive arrangements may be employed.

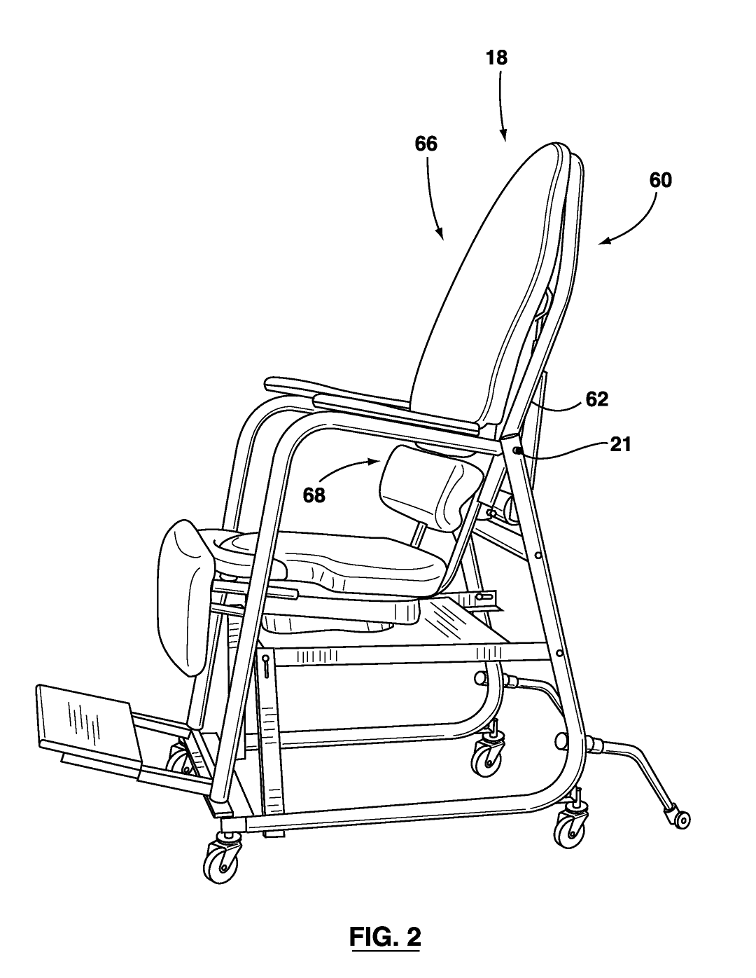

Referring to FIG. 2, the back support portion 18 includes a back frame 60 with a pair of peripheral regions, provided by longitudinal frame portions 62, respectively coupled with the first pivot portions 21. Each frame portion 62 includes an end portion 64 (FIG. 3) and each corresponding first pivot portion 21 is offset from a corresponding end portion 64. The back support portion 18 includes an upper back support cushion 66 and a lower back support cushion 68, the latter coupled to the end portions 64 and spanning the space between the frame portions 62.

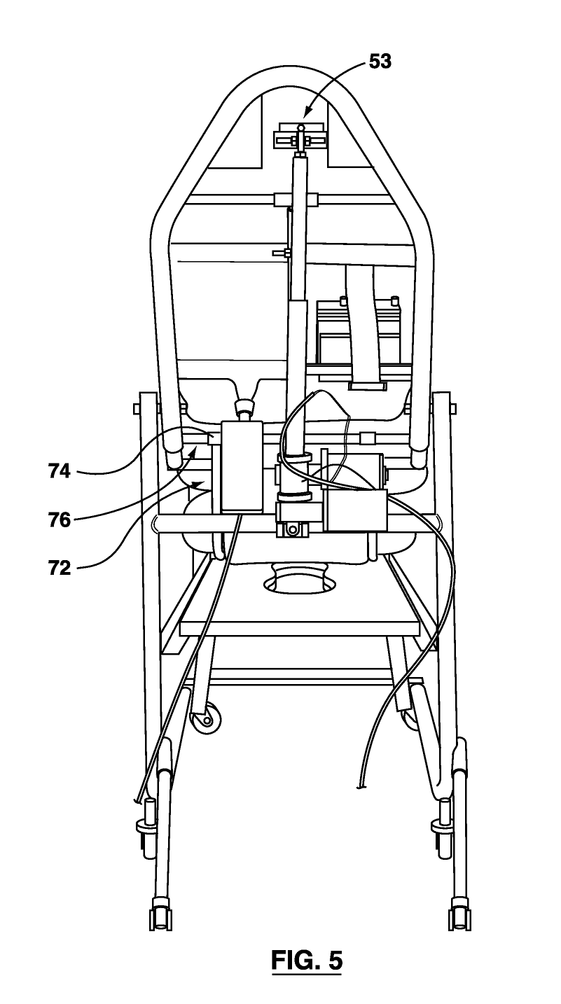

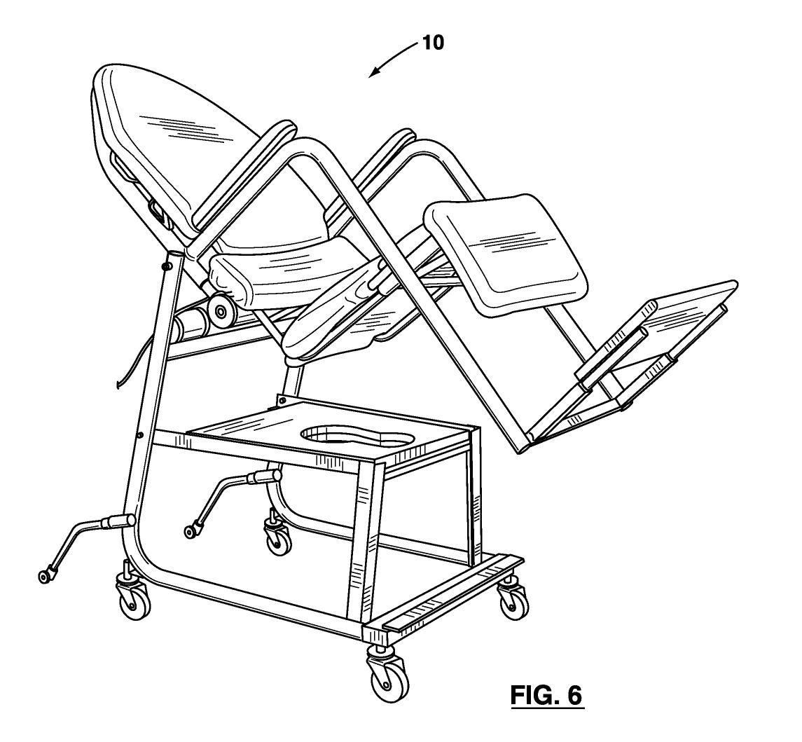

Referring to FIG. 4, the seat support portion 30 includes a seat frame member 72 and a pair of second pivot portions 74 (FIG. 5) to couple the seat frame member 72 to the back support portion 18. The back support portion 18 includes a second cross member 76 extending between the end portions 64. In this case, the second pivot portions 74 couple corresponding ends of the seat frame member 72 to the second cross member 76. The seat support portion 30 includes a third cross member 78, and the second drive unit 52 is mounted between the third cross member 78 and the back support portion 18 at 53.

Referring to FIG. 1, the leg support portion 22 includes an upper cushioned support portion 80 to align with a patient's legs below the patient's knees. The patient support 16 includes a pair of side frame portions 82 each extending from the back support portion 18 to a distal region 84, with arm rests shown at 86. A foot support portion 88 extends between the side frame portions 82. In this example, the leg support portion is adjustable in position relative to the side frame portions 82, to adjust a profile of the leg support portion relative to the back support. The leg support portion further includes a pair of first coupling elements 90a, 90b (FIG. 7) movably engaged with a corresponding pair of complementary second coupling elements. The first and second coupling elements are respectively attached to the side frame portions and the leg support portion 80, allowing movement of the leg support portion 80 as shown in dashed lines in FIG. 7.

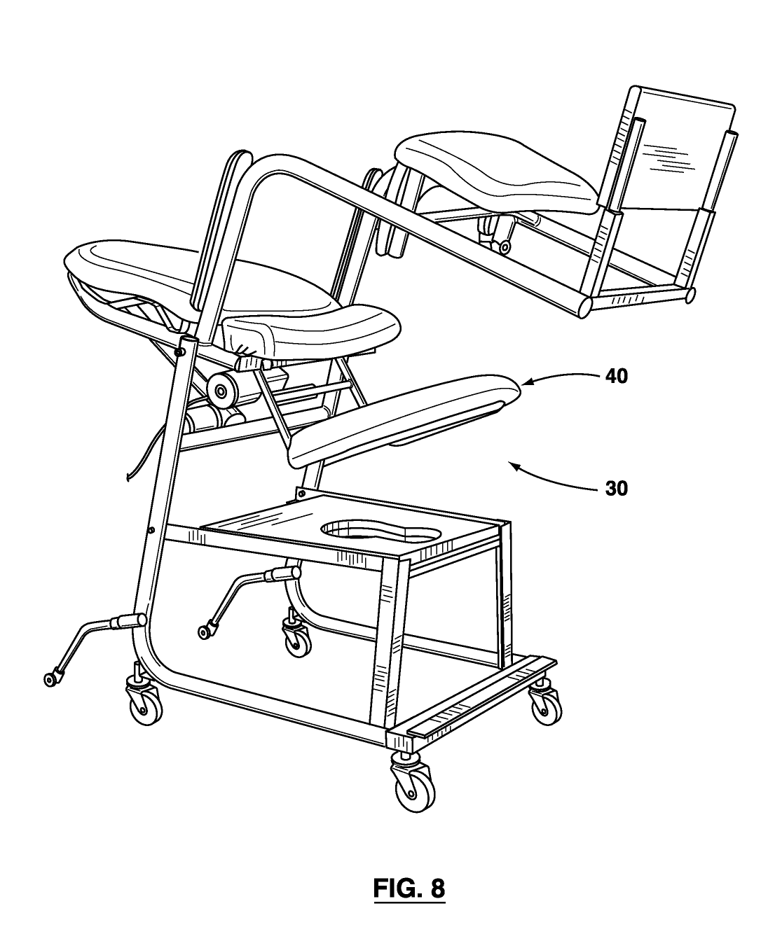

Thus, the carrier 10 is configured to transfer the back and leg support portions 18, 22 between the upright and inclined orientations, under the action of the first drive unit 50, and to transfer the seat support portion 30 between a proximal position (FIG. 7) and an intermediate distal position (FIG. 8 or 9) under the action of the second drive unit 52, when the back support portion 18 is in the inclined orientation.

The carrier 10 thus provides a method of supporting a patient for a toileting function. First, the carrier is prepared to receive a patient, with the seat positioned in its patient supporting position as shown in FIG. 1. The patient may then comfortably and supportably seated in such a manner that the back support portion 18, the seat support portion 30 and leg support portion 22 are properly adjusted, so that the back and leg support portions can support the patient in an inclined orientation, as will be described.

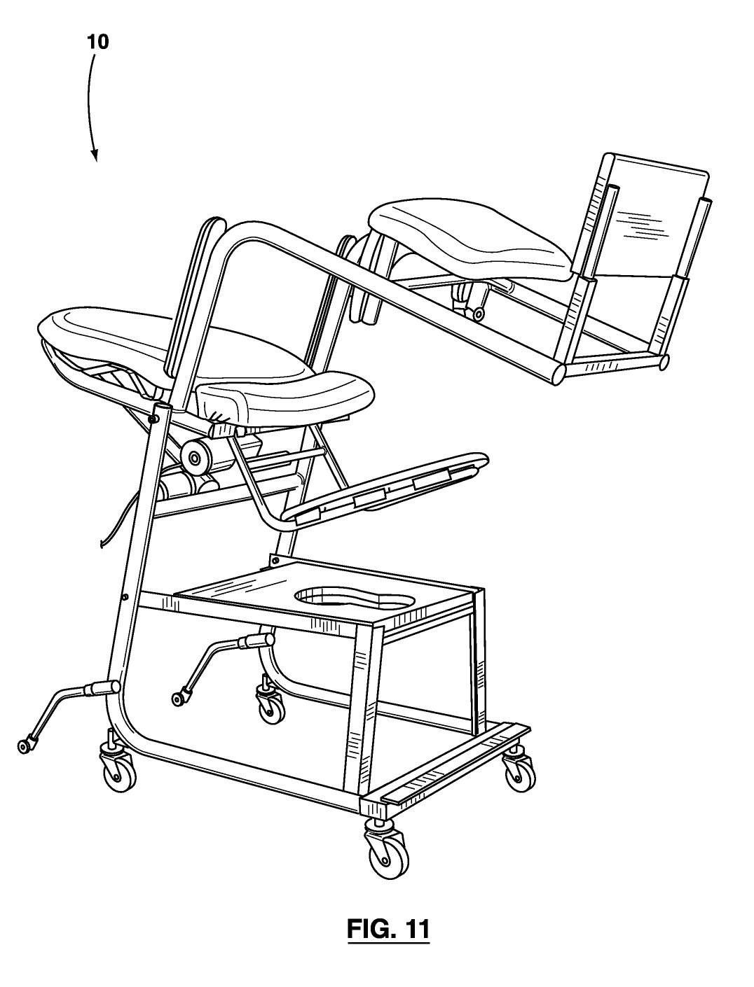

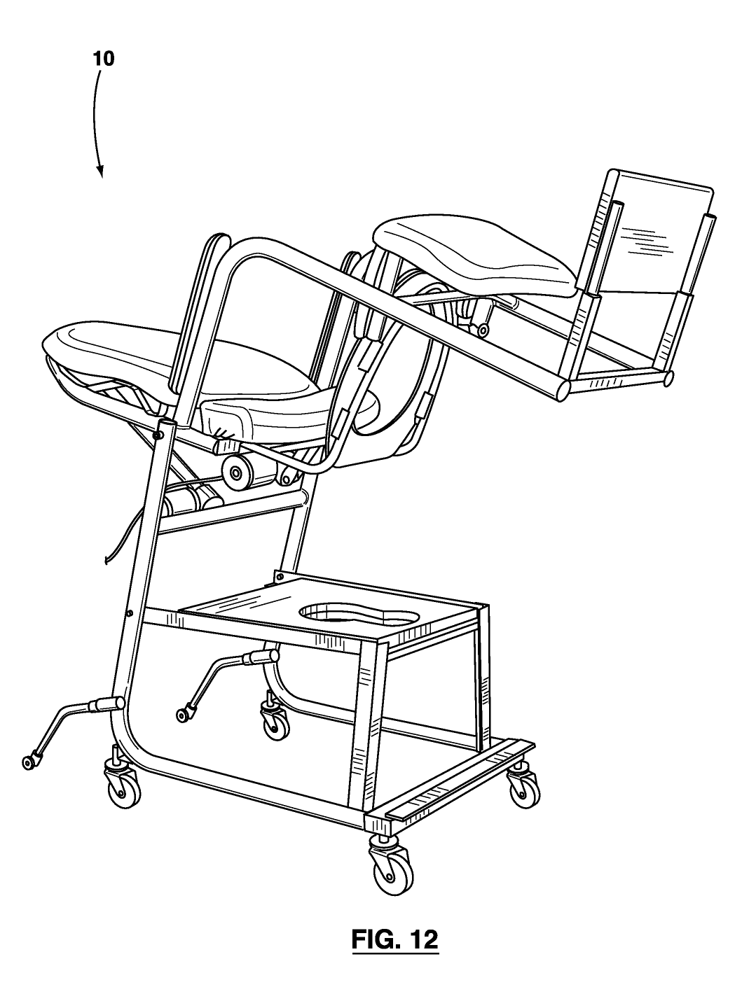

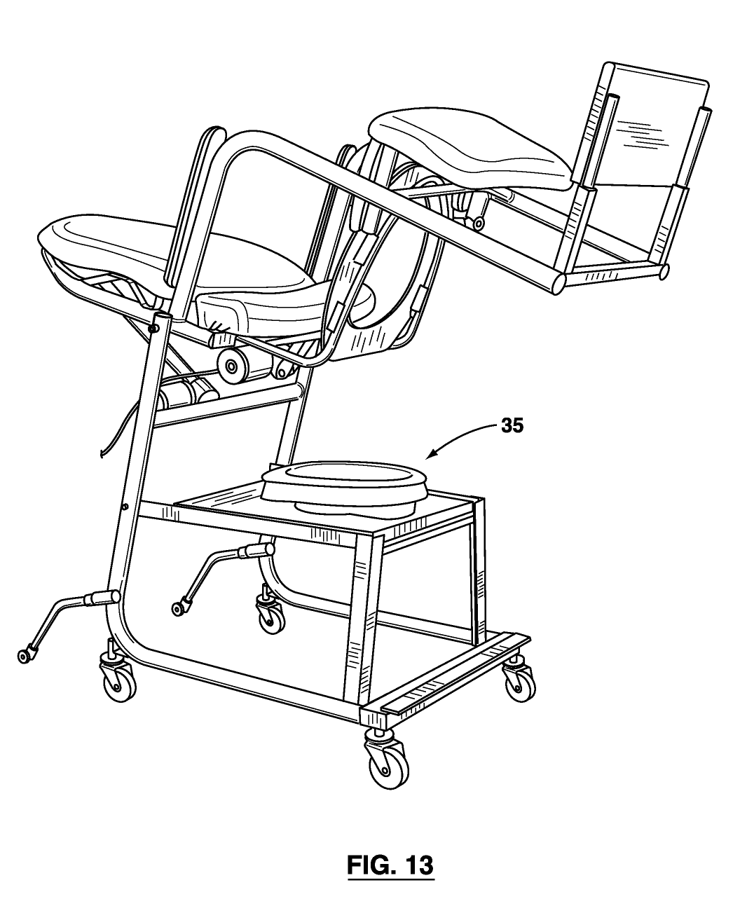

The first drive unit 50 is then activated to incline the carrier 10 from the position shown in FIG. 1 to the position shown in FIG. 7, namely to a sufficient degree that the patient's weight is comfortably supported between the back support portion 18 and the leg support portion 22, that is without the need for the seat support portion 30 to provide such support. The second drive unit 52 may then be activated to transfer the seat support portion 30 from a patient-contacting location, as shown in FIG. 7, to an intermediate distal location, as shown progressively in FIGS. 8 and 9. In this case, this intermediate position is chosen to provide sufficient room to allow the seat support portion 30 to be converted from its non-toileting configuration (that is with the seat support cushion 40) to a toileting configuration by way of a toileting seat shown in FIG. 10. In this case, both the seat cushion 40 and the toileting seat 42 may be provided with clip members for removable connection with the seat frame, though other couplings may also be employed as desired. (Alternatively, the seat support cushion 40 may be removably coupled to the seat frame and/or the toileting seat 42, while the latter may remain on the seat frame member 72. In this case, the seat cushion 40 would be removed to reveal the toileting seat 42.) With the toileting seat 42 in place, the second drive unit 52 may then be employed to return the seat support portion to its proximal patient-contacting location until it makes contact with the buttocks region of the patient, that is through the position shown in FIG. 11 to the position shown in FIG. 13.

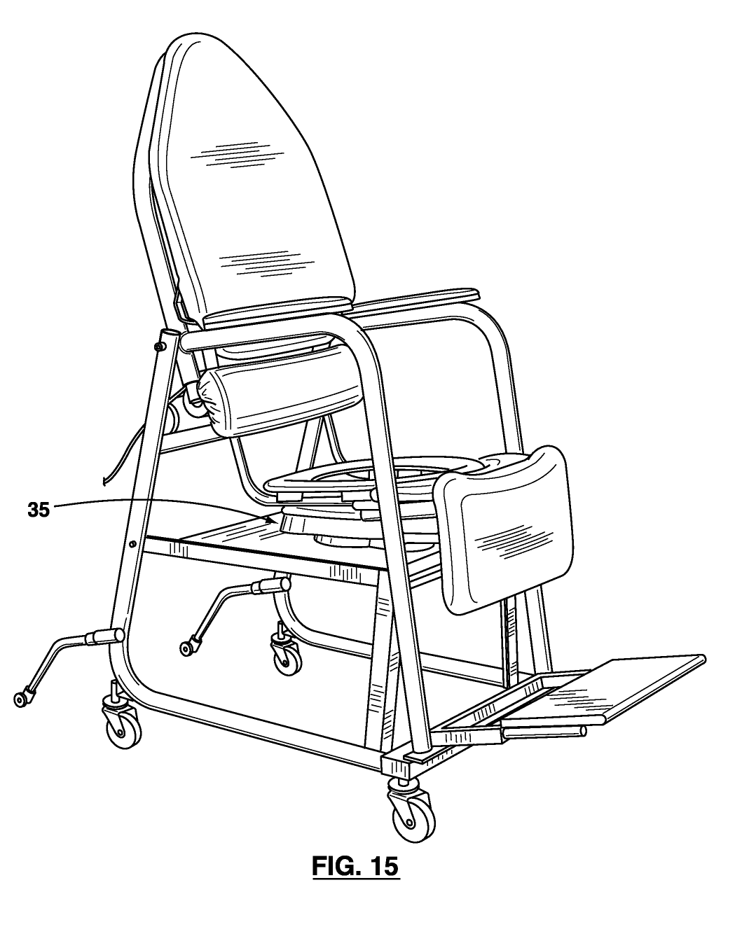

The first drive unit 50 may then be employed to return the back support portion, seat support portion and leg support portion collectively to deliver the patient through the position shown in FIG. 14 to an upright position of FIG. 15, in which the seat support portion is aligned with and above the toileting receptacle 35, so that the patient may proceed with a toilet function. In this case, the inclined position allows the patient to be in relative comfort with her body supported by the back support portion and the leg support portion, while the seat support portion is converted as above described. This configuration also allows the caregiver being able to attend to necessary post-toileting cleaning with the patient in an relatively accessible location, without undue kneeling or bending

The process may then be reversed as shown in the figures to return the patient to a normal seating configuration with the seat cushion in place.

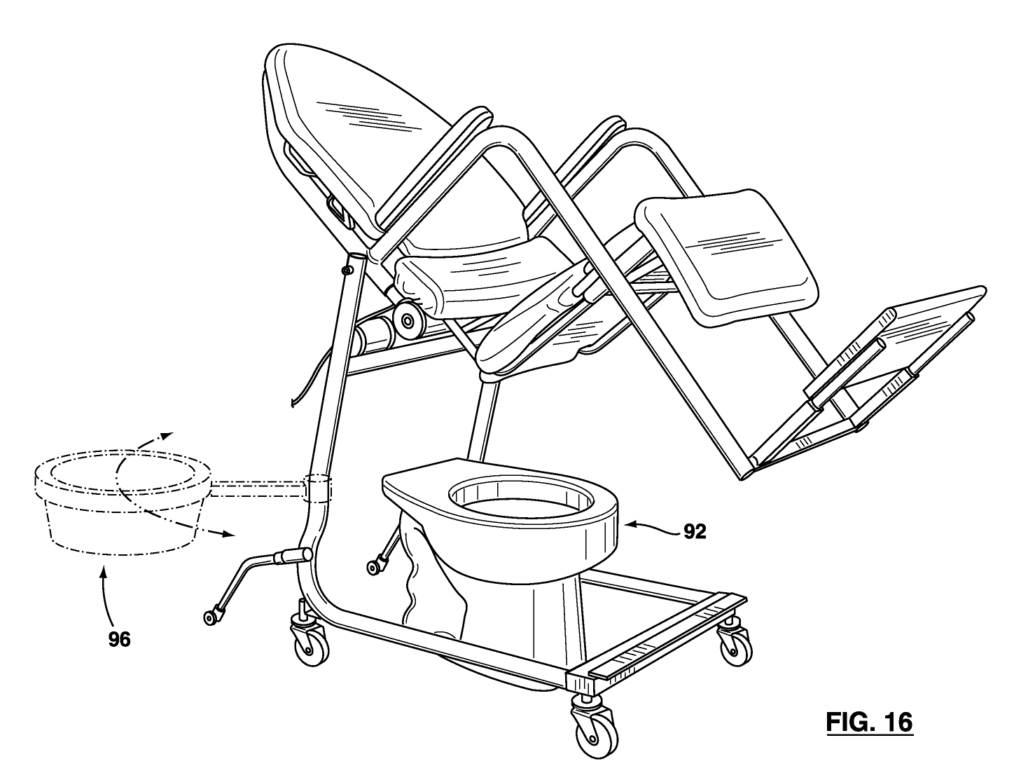

The base 12 may be provided in different configurations. For instance, as shown in FIG. 16, as an alternative to the use of the platform portion 19 and the portable toileting receptacle, the base may be configured to permit the carrier 10 to be located above a fixed toilet 92. In one example, the base frame members may provide sufficient spacing between them for the toilet 92 to be so-located. Thus, in this case, the carrier 10 is positioned directly over a toilet 92, to reduce hazards in handling waste. The use of the toileting receptacle (such as a pot or a bedpan) may provide flexibility if a toilet with appropriate access space is not available. Alternatively, a cantilevered mechanism, arm, moveable carrier or the like may be used to transfer or swing a toileting receptacle to beneath the chair, as shown, schematically as an example, at 96 in FIG. 16.

Thus, advancing the carrier to the inclined orientation allows for the seat support portion (or seat) to be displaced to create a substantial access region (in an area at a comfortable working height that is no longer supporting the patient's weight). This allows the caregiver to remove/replace the pants/underwear/briefs and allows access for thorough cleaning.

In the case of carrier 10, and particularly having regard to the placement of the drive units, they are located in a region confined in or otherwise located behind the back support portion 18 and sufficiently high so as to permit the carrier 10 to be positioned above a toilet and away sources of fluids and the like.

While a device or assembly and an accompanying method have been described for what are presently considered the exemplary embodiments, the invention is not so limited. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A patient carrier, comprising a patient support configured to be locatable above a toileting receptacle, the patient support including a back support portion; a leg support portion, and a seat support portion; the patient support being movable about a first axis between an upright orientation and an inclined orientation, the seat support portion being movable about a second axis relative to the back support portion and leg support portion, and operable to transition between a seating configuration and a toileting configuration when the patient support is in the inclined orientation.

2. A carrier as defined in claim 1, the seat support portion including a seat frame portion configured to support a seat support cushion segment and/or a toileting seat segment removably positioned thereon.

3. A carrier as defined in claim 1, further comprising a first drive portion to transfer the patient support between the upright orientation and inclined orientations, and/or a second drive portion to transfer the seat support portion between the seating and toileting configurations.

4. A carrier as defined in claim 3, the first and second drive portions being located in a region behind the back support portion when the patient support is in the upright orientation.

5. A carrier as defined in claim 1, further comprising a receptacle support for the toileting receptacle.

6. A carrier as defined in claim 5, the receptacle support being movable from an operative position beneath the seat support portion to a location distal thereto.

7. A carrier as defined in claim 1, the receptacle support including a platform with a passage to receive a portable toileting receptacle.

8. A carrier as defined in claim 1, the first axis being spaced from the second axis.

9. A method of preparing a patient carrier for toileting, comprising:
i) orienting the patient carrier in an upright orientation, with a back support portion, a leg support portion, and a seat support portion available for supporting a patient;
ii) with the seat support in a seating configuration, transitioning the patient carrier to an inclined orientation;
iii) with the patent carrier in the inclined position, and with the back support and leg support positions oriented to support the patient, transitioning the seat support portion from the seating configuration to a toileting configuration; and
iv) transitioning the patient support to a toileting orientation which is configured to be above a toileting receptacle.

10. A toileting carrier, comprising a patient support movable about a first axis relative to a base, the patient support including a back support portion, a pair of arm support portions, and a leg support portion; a seat support portion movable about a second axis relative to the back portion and leg support portions, between a first patient supporting position and a second position distal thereto, the base being configured to permit a toileting receptacle to be located beneath the seat support portion, the seat support portion including a seat frame portion, the seat frame portion configured to support a seat support cushion segment or a toileting seat segment removably positioned thereon, a first drive portion to transfer the patient support between an upright orientation and an inclined orientation, and a second drive portion to transfer the seat support portion between the first and second positions.

11. A carrier as defined in claim 10, the patient support including a pair of side frame portions each extending from the back support portion to a distal region, a foot support portion extending between the side frame portions.

12. A carrier as defined in claim 11, the base providing a pair of first pivot portions to form the first axis, the back support portion including a back frame, the back frame including a pair of end regions coupled with the pivot portions.

13. A carrier as defined in claim 12, the back support portion including an upper back support member and a lower back support member, the latter extending between the end regions.

14. A carrier as defined in claim 13, the receptacle support including a platform positioned on the base with a passage to receive a portable toileting receptacle.
